(19) United States
(12) Patent Application Publication
(10) Pub. No.: US 2026/0035297 A1
(43) Pub. Date: Feb. 5, 2026

(54) SUPPLEMENTARY CEMENTITIOUS MATERIAL COMPOSITION AND METHOD OF MAKING

(71) Applicant: EnviCore Inc., Calgary (CA)

(72) Inventors: Aseem Pandey, Calgary (CA); Shahrukh Shamim, Calgary (CA)

(73) Assignee: EnviCore Inc., Calgary, AB (CA)

(21) Appl. No.: 19/099,762

(22) PCT Filed: Aug. 4, 2023
(86) PCT No.: PCT/CA2023/051051

§ 371 Date: Jan. 29, 2025

Related U.S. Application Data
(60) Provisional application No. 63/395,285, filed on Aug. 4, 2022.

(51) Int. Cl. C04B 7/30; C04B 7/153; C04B 7/24; C04B 7/43; C22B 7/00; C22B 7/04

(52) U.S. Cl. CPC C04B 7/30; C04B 7/153; C04B 7/243; C04B 7/434; C22B 7/007; C22B 7/04

(57) ABSTRACT

A method for producing supplementary cementitious material. The method comprises contacting a mineral stream with an acid to form an activated mineral stream; reducing the moisture content of the mineral stream; and comminuting the mineral stream to form a supplementary cementitious material. A method of extracting a metal from a mineral stream. The method comprises contacting a mineral stream with an acid to form an activated mineral stream; filtering the activated mineral stream to extract leach liquor comprising the metal; and neutralizing the acid.

### CROSS-REFERENCE TO RELATED APPLICATIONS

This application claims priority to and the benefit of the filing of U.S. Provisional Patent Application No. 63/395,285, entitled “SUPPLEMENTARY CEMENTITIOUS MATERIAL COMPOSITION AND METHOD OF MAKING”, filed on Aug. 4, 2022, and the specification thereof is incorporated herein by reference.

### BACKGROUND OF THE INVENTION

### Field of the Invention (Technical Field)

The present invention relates to methods of producing materials and compositions comprising supplementary cementitious materials.

### BACKGROUND ART

Note that the following discussion may refer to one or more publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

Cement is a vital component of industrialized society and is the second most consumed product globally after potable water. Cement, a key element of concrete, is used in almost all structures, including houses, skyscrapers, dams, roads, and bridges. At the same time, cement is also a major contributor to global CO₂ emissions. Cement manufacturing accounts for up to 7% of global CO₂ emissions with every ton of cement produced resulting in one ton of CO₂ released into the atmosphere. The pressure for the cement industry to decarbonize has increased rapidly, from society as well as from governments and investors. Therefore, achieving net zero by 2050 is a critical goal for cement companies globally.

Supplementary cementitious material (“SCM”) is produced using globally abundant waste mineral streams such as tailings waste from mining operations. Different production methods may be used to produce SCMs depending on the characteristics of the waste stream. One method includes low temperature chemical activation of the minerals combined with milling for further activation and size reduction. Other methods include thermal activation in combination with chemical activation and ball milling for size reduction and activation. The SCMs can be used in concrete compositions to reduce CO₂ emissions associated with cement production.

SCMs have been used to lower the CO₂ emissions associated with Portland cement. The environmental impact of concrete is improved, including decreases in greenhouse gases (“GHGs”) and air pollutants, with each portion of Portland cement replaced with SCMs. Furthermore, reusing SCMs as raw materials for another operation decreases waste because SCMs are often by-products of other industrial processes and are generally disposed of in landfills. The use of cementitious blends not only results in stronger, more durable high-performance concretes, but also helps reduce global climate impact by lowering energy consumption and GHG emissions. Examples of commonly used SCMs include ground granulated blast furnace slag (“GGBFS”), a by-product of the iron industry; fly ash, a by-product of coal combustion in power plants; other pozzolans such as calcined clays; metakaolin; and silica fume. SCMs are also characterized as pozzolanic materials with an amorphous siliceous or siliceous and aluminous content. The amorphous siliceous or siliceous and aluminous content participates in a pozzolanic reaction with Ca(OH)₂ to produce a hydrated calcium silicate compound with cementitious properties. Certain SCMs, such as fly ash, have several disadvantages including slower strength gain; longer setting times; increased need for air-entraining admixtures; geographic limitations; and most critically, future availability due to shutting down of coal plants. The supply of SCMs is not currently sufficient to meet demand and is declining. The shortage of fly ash in certain markets has also driven up the costs of SCM waste. Other SCMs like metallurgical slags, natural pozzolans like volcanic ash, and metakaolin cannot completely replace fly ash because of their low supply volumes, geographic limitations, and higher supply prices. Pozzolans may also be artificially produced. For example, calcined clay or metakaolin may be produced from kaolin mineral. The calcination temperature for preparing calcined clays is generally lower than for cement production and no CO₂ emissions occur due to limestone breakdown in cement. Therefore, activation of minerals with siliceous or siliceous and aluminous content to prepare SCMs can play a major role in decarbonization of the cement industry.

Tailings can include solid wastes from ore beneficiation processes performed by mineral extraction industries and are available in huge amounts. There are currently 50+billion m³ of tailings waste which is expected to rise to 70+ billion m³ within the next five years. The chemical composition of tailings primarily includes SiO₂, Al₂O₃, CaO, and Fe₂O₃ and similar compounds. However, these minerals are mostly non-reactive due to their high degree of crystallinity and cannot be classified as a pozzolan.

Fly ash and slag are the major SCMs currently in use for blending in cement mixes. However, the cement industry has driven demand to an extent where in certain places these waste materials are as expensive as cement. Moreover, these major SCMs are subject to geographic limitations and reduced production in the near future due to closure of coal plants. Natural pozzolans are another source of SCMs but are geographically limited. Similarly, calcined clays and metakaolin can be used but require high temperature calcination (e.g., 700° C.-900° C.).

The major issues associated with the global availability of large amounts of SCMs can be addressed using tailings waste from the mining industry. Not only do tailings provide an enormous source of sustainable building materials, but their use in SCMs also eliminates the environmental impacts of both the mining industry and the construction industry. Moreover, mineral tailings also have substantial amount of residual metals such as nickel, copper, etc.

Therefore, there is a need to sustainably produce SCMs to meet the huge demand by the cement industry. The large volume of tailings waste can be an excellent source for SCM production. Described herein is a method to prepare SCMs from tailings using acid activation at room temperature or a combination of low temperature calcination and acid activation at room temperature. In certain embodiments, such as embodiments directed to mineral tailings, the feed may be dewatered to recover leached energy transition metals such as nickel and copper from the water.

### BRIEF SUMMARY OF THE INVENTION

Embodiments of the present invention relate to a method of producing supplementary cementitious material, the method comprising: contacting a mineral stream with an acid to form an activated mineral stream; reducing the moisture content of the mineral stream; and comminuting the mineral stream to form a supplementary cementitious material.

In another embodiment, the mineral stream comprises tailings. In another embodiment, the mineral stream is contacted with the acid for about 1 to about 24 hours. In another embodiment, reducing the moisture content comprises drying. In another embodiment, comminuting comprises ball milling. In another embodiment, the acid comprises hexafluorosilicic acid. In another embodiment, the acid comprises sulfuric acid. In another embodiment, the acid comprises phosphoric acid. In another embodiment, the method further comprises calcining the activated mineral stream. In another embodiment, the activated mineral stream is calcined at a temperature of about 500° C. to about 700° C. In another embodiment, the mineral stream comprises asbestos tailings. In another embodiment, the mineral stream comprises laterite tailings. In another embodiment, the mineral stream comprises oil sand tailings.

Embodiments of the present invention also relate to a method of extracting a metal from a mineral stream, the method comprising: contacting a mineral stream with an acid to form an activated mineral stream; filtering the activated mineral stream to extract leach liquor comprising the metal; and neutralizing the acid.

In another embodiment, the acid comprises hexafluorosilicic acid. In another embodiment, the mineral stream comprises tailings. In another embodiment, the mineral stream comprises sludge. In another embodiment, the mineral stream comprises slag. In another embodiment, neutralizing the acid comprises contacting the activated tailings with a caustic. In another embodiment, the caustic comprises lime.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a schematic showing SCM preparation at room temperature using acid activation of tailings, according to an embodiment of the present invention;

FIG. 2 is a schematic showing SCM preparation at room temperature using acid activation of tailings and calcination, according to an embodiment of the present invention;

FIG. 3 is a graph showing the compressive strength of SCM cement compositions prepared from oil sand tailings after 7 and 28 days compared to cement, according to an embodiment of the present invention;

FIG. 4 is a graph showing the compressive strength of SCM cement compositions prepared from zinc tailings after 7 and 28 days compared to cement, according to an embodiment of the present invention;

FIG. 5 is a graph showing the compressive strength of SCM cement compositions prepared from copper tailings after 7 and 28 days compared to cement, according to an embodiment of the present invention;

FIG. 6 is a graph showing the compressive strength of SCM cement compositions prepared from asbestos tailings after 7 and 28 days compared to cement, according to an embodiment of the present invention;

FIG. 7 is a graph showing the compressive strength of SCM cement compositions prepared from laterite tailings after 7 and 28 days, according to an embodiment of the present invention;

FIG. 8 is a graph showing the compressive strength of SCM cement compositions prepared from recycled concrete after 7 and 28 days, according to an embodiment of the present invention;

FIG. 9 is a graph showing the compressive strength of SCM cement compositions prepared from nickel tailings after 7 days, according to an embodiment of the present invention;

FIG. 10 is a graph showing the compressive strength of SCM cement compositions prepared from nickel tailings after 28 days, according to an embodiment of the present invention;

FIG. 11 is a graph showing the compressive strength of SCM cement compositions prepared from copper tailings after 7 days, according to an embodiment of the present invention;

FIG. 12 is a graph showing the compressive strength of SCM cement compositions prepared from copper tailings after 28 days, according to an embodiment of the present invention;

FIG. 13 is a graph showing the compressive strength of SCM cement compositions prepared from bottom ash, basalt, copper slag, and zeolite after 7 days, according to an embodiment of the present invention; and

FIG. 14 is a graph showing the compressive strength of SCM cement compositions prepared from bottom ash, basalt, copper slag, and zeolite after 28 days, according to an embodiment of the present invention.

### DETAILED DESCRIPTION OF THE INVENTION

This invention relates to the method of producing supplementary cementitious materials using waste streams and/or mineral tailings as feedstock for use in concrete compositions.

The invention also relates to concrete compositions comprising supplementary cementitious materials produced from waste streams and/or mineral tailings.

The term “mineral stream” is defined herein to mean any tailings, tailings mineral, and/or waste stream.

The terms “tailings” or “tailings mineral” are used interchangeably and are defined herein as waste materials left after a target mineral is extracted from ore, tailings, waste, oil and gas operations, or other processes.

The terms “waste stream” or “waste streams” are defined herein as waste materials left after an industrial, mining, or manufacturing process. A waste stream includes, but is not limited to, recycled concrete, bottom ash, basalt, copper slag, zeolite, or other materials.

The term “mineral” is defined herein as a solid chemical compound comprising a crystal structure.

The term “pozzolan” is defined herein as a siliceous or siliceous and aluminous material that in itself possesses little cementitious value but will chemically react with calcium hydroxide to form compounds having cementitious properties.

ASTM C618 refers to the standard specification for coal fly ash and raw or calcined natural pozzolan for use in concrete as defined by ASTM international.

ASTM C311 refers to the standard test methods for sampling and testing fly ask or natural pozzolans for us in Portland-cement concrete. as defined by ASTM international.

The term “acid” or “acids” is defined herein as a solution with a pH below 7.

The term “tank” is defined herein as a vessel, chamber, container, receptacle, and/or other object capable of containing a fluid. The term shall encompass any vessel, chamber, container, receptacle, and/or other object of suitable scale or material. For example, it may include a large acid-resistant tank for mining applications.

The terms “metal” or “metals” are defined herein as a compound, mixture, or substance comprising a metal atom. The term “metal” or “metals” includes, but is not limited to, metal hydroxides, metal oxides, metal salts, elemental metals, metal ions, non-ionic metals, minerals, or a combination thereof. The metal may include, but is not limited to, neodymium (“Nd”), praseodymium (“Pr”), dysprosium (“Dy), copper (“Cu”), lithium (“Li”), sodium (“Na”), magnesium (“Mg”), potassium (“K”), calcium (“Ca”), titanium (“Ti”), vanadium (“V”), chromium (“Cr”), manganese (“Mn”), iron (“Fe”), cobalt (“Co”), nickel (“Ni”), cadmium (“Cd”), zinc (“Zn”), aluminum (“Al”), silicon (“Si”), silver (“Ag”), tin (“Sn”), platinum (“Pt”), gold (“Au”), bismuth (“Bi”), lanthanum (“La”), europium (“Eu”), gallium (“Ga”), scandium (“Sc”), strontium (“Sr”), yttrium (“Y”), zirconium (“Zr”), niobium (“Nb”), molybdenum (“Mo”), ruthenium (“Ru”), rhodium (“Rh”), palladium (“Pd”), indium (“In”), hafnium (“Hf”), tantalum (“Ta”), tungsten (“W”), rhenium (“Re”), osmium (“Os”), iridium (“Ir”), mercury (“Hg”), lead (“Pb”), polonium (“Po”), cerium (“Ce”), samarium (“Sm”), erbium (“Er”), ytterbium (“Yb”), thorium (“Th”), uranium (“U”), plutonium (“Pu”), terbium (“Tb”), promethium (“Pm”), tellurium (“Te”), or a combination thereof.

The invention also relates to methods for activating tailings to produce SCM. The tailings may comprise oxygen-containing compounds including, but not limited to, SiO₂, Al₂O₃, CaO, and Fe₂O₃, or a combination thereof. The tailings may comprise a high degree of crystallinity, e.g., about 80%, and may not function and/or be classified as a pozzolan. Increasing the specific area and/or decreasing in particle size of a pozzolan may expose a greater surface to chemical reaction to enhance reactivity. Amorphous pozzolan and/or SCM structures may be more reactive than crystalline structures because of the greater mobility and superficial location of their atoms.

Tailings and/or waste streams (e.g., the mineral stream) may be activated to at least partially alter their crystalline structure and form an amorphous structure. Activation of tailings minerals and/or waste streams comprises contacting the tailings with an acid. The acid may include, but is not limited to, HCl, HNO₃, H₂SO₄, H₂[SiF₆], and organic acids including, but not limited to, citric acid and carbonic acid, or a combination thereof. Hexafluorosilicic (“HFS”) acid may be used for tailings activation due to higher dissolution rate of silicates in the presence of fluoride. The acid activation may result in dissolution of tailings and/or waste streams with the loss of their crystalline structure and forming of residual amorphous structure. The acid activation may then be followed by ball milling to reduce the particle size and increase the specific surface area. In certain cases, ball milling may be done first to increase the specific surface area, followed by acid activation to cause structural disordering and reduction in crystallinity. The prepared SCMs may then used to replace approximately at least 20% of the cement in a mortar mix and measurement of compressive strength may be done after 7 and 28 days, or after another suitable period of time.

The tailings and/or waste stream may be crystalline. The tailings and/or waste stream may at least about 10%, about 10% to about 99%, about 20% to about 97%, about 30% to about 95%, about 40% to about 90%, about 50% to about 80%, about 60% to about 70%, or about 99% crystalline in structure.

Another aspect of the invention includes activation of the tailings minerals and/or waste streams through calcination. Calcination may occur at a temperature of at least about 400° C., about 400° C. to about 650° C., about 450° C. to about 600° C., about 500° C. to about 550° C., or about 600° C. Calcination may be followed by acid activation and/or ball milling. Tailings minerals and/or waste streams may first be ball milled, which may be followed by calcination to ensure proper calcination of the minerals. The calcination may result in partial reduction in crystallinity which may be further reduced by acid activation. The combination of calcination and acid activation may result in amorphization of highly crystalline tailings minerals and/or waste streams. Amorphization may allow the tailings to be suitable as an SCM. Calcination or acid activation alone may not achieve enough amorphization on tailings minerals to act as an SCM which produces similar strength as cement at 20% replacement levels for certain tailings and/or waste streams. The prepared SCMs may then be used to replace at least about 5%, about 5% to about 40%, about 10% to about 35%, about 15% to about 30%, about 20% to about 25%, or about 40% of the cement in a mortar mix. Replacement may be done as per ASTM C618 and measurement of compressive strength may be done after 7 and 28 days, or after another suitable period of time.

The tailings mineral may include, but is not limited to, oil sands tailings, zinc, lead tailings, copper tailings, base metal tailings, precious metal tailings, coal waste tailings, asbestos tailings, nickel laterite tailings, gold tailings, diamond tailings, silver tailings, aluminum tailings, iron tailings, clay tailings, or a combination thereof. The waste stream may include, but is not limited to, recycled concrete, glass, fly ash, or a combination thereof. The tailings and/or waste stream may be activated using calcination and acid activation to replace a percentage, e.g., 5% to 40%, of cement in a mortar mix.

The tailings and/or waste stream may be contacted (e.g., aged) with an acid for at least about 1 hour, about 1 hour to about 36 hours, about 4 hours to about 32 hours, about 8 hours to about 28 hours, about 12 hours to about 24 hours, about 16 hours to about 20 hours, or about 36 hours. The tailings and/or waste stream may be contacted (e.g., aged) with an acid to form a slurry. The slurry may be aged and/or allowed to sit to form a sludge. The sludge may be dried to have a moisture content of at least about 0.1%, about 0.1% to about 2%, about 0.3% to about 1.5%, about 0.5% to about 1.0%, or about 2%. The dried sludge may be milled including, but not limited to, ball milling or roll milling or other comminution, and sieved to form SCM particles with a diameter of at least about 5 μm, about 5 μm to about 50 μm, about 10 μm to about 45 μm, about 15 μm to about 40 μm, about 20 μm to about 35 μm, about 25 μm to about 30 μm, or about 50 μm.

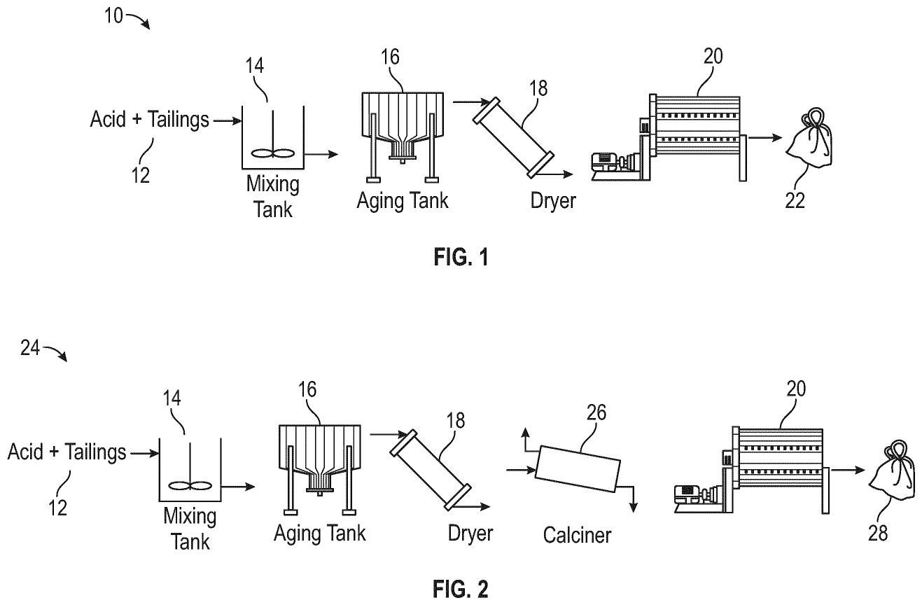

Turning to the drawings, FIG. 1 shows a schematic for SCM preparation at room temperature using acid activation of tailings. Dried or wet tailings sludge is mixed with HFS acid for acid activation. The tailings slurry is then left to react in an aging tank for 1-24 hours depending on the tailing's composition, forming a sludge (e.g., the activate tailings). After acid treatment, the sludge is fed to a dryer (e.g., rotary dryer) to reduce the moisture content below e.g., 1%, to ensure proper dry milling in a mill or other comminution process. After milling of the acid activated tailings, the prepared SCM is sieved to a certain size limit (generally less than 45 μm) and bagged. Activation process 10 shows acid and tailings mixture 12 disposed within mixing tank 14 and allowed to react in aging tank 16 to form a treated tailings sludge (e.g., the activate tailings). The activated tailings is dried in dryer 18 and milled in ball mill 20 to produce SCM product 22.

FIG. 2 shows a schematic for SCM preparation using acid activation of tailings and calcination. The acid activated tailings is further calcined at a temperature of about 500° C.-700° C. to further activate the tailings. The tailings feed after acid activation and calcination is ball milled and bagged for use. Activation process 24 shows acid and tailings mixture 12 disposed within mixing tank 14 and allowed to react in aging tank 16 to form a treated tailings sludge (e.g., the activate tailings). The activated tailings is dried in dryer 18, heated in calciner 26, and milled in ball mill 20 to produce SCM product 28.

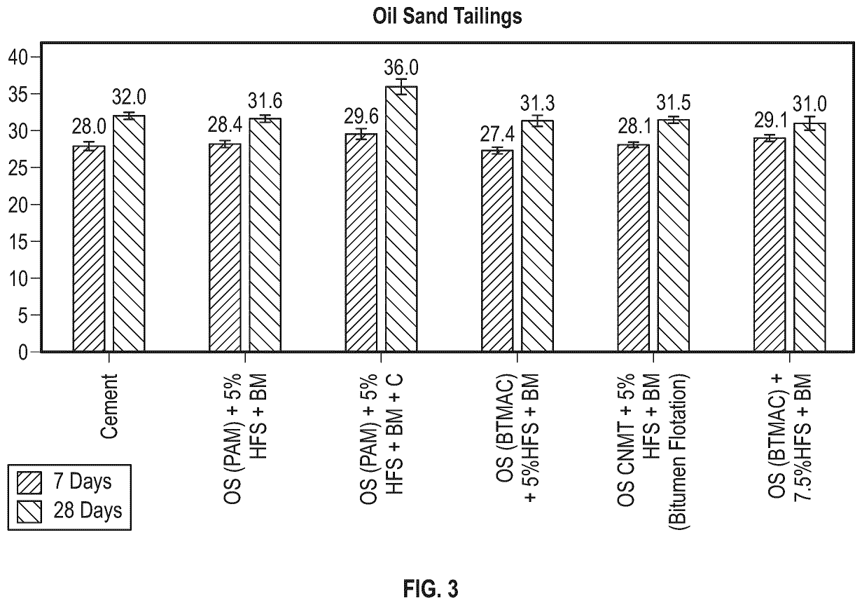

FIG. 3 shows the compressive strength of SCM prepared from oil sand tailings after 7 and 28 days. The compressive strength of the mortar samples prepared with 20% of SCM from oil sand tailings is shown. SCMs from oil sands (“OS”) with polyacrylamide (“PAM”), hexafluorosilicic (“HFS”) acid, benzyltrimethylammonium chloride (“BTMAC”), ball milling (“BM”), and/or calcination (“C”) are compared to cement. The compressive strength of the SCMs from oil sand tailings was not significantly different than cement.

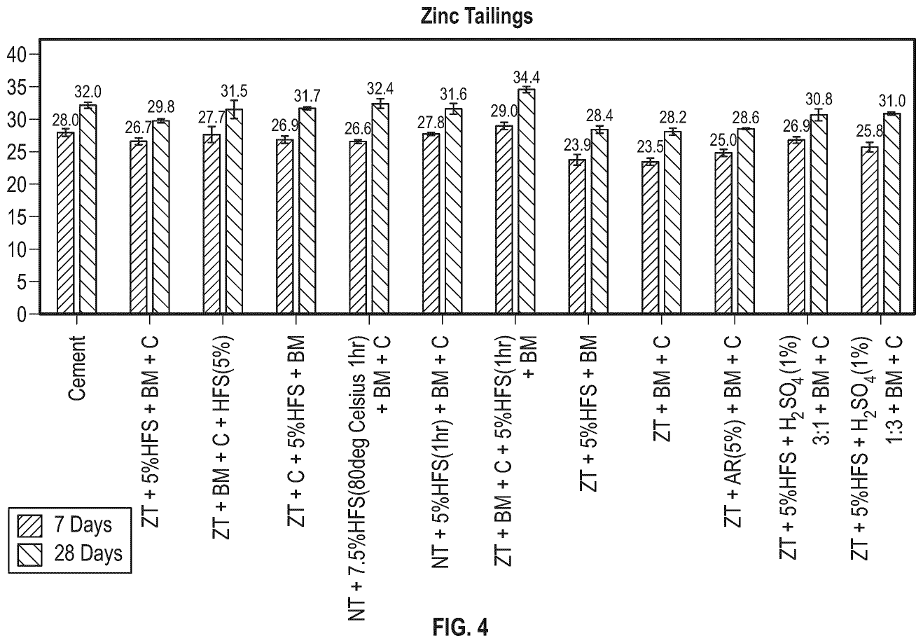

FIG. 4 shows the compressive strength of SCM prepared from zinc tailings after 7 and 28 days. The compressive strength of the mortar samples prepared with 20% of SCM from zinc tailings is shown. SCMs from zinc tailings (“ZT”) with hexafluorosilicic (“HFS”) acid, ball milling (“BM”), calcination (“C”), and/or sulfuric acid (“H₂SO₄”) were compared to cement. The compressive strength of the SCMs from zinc tailings is not significantly different than cement.

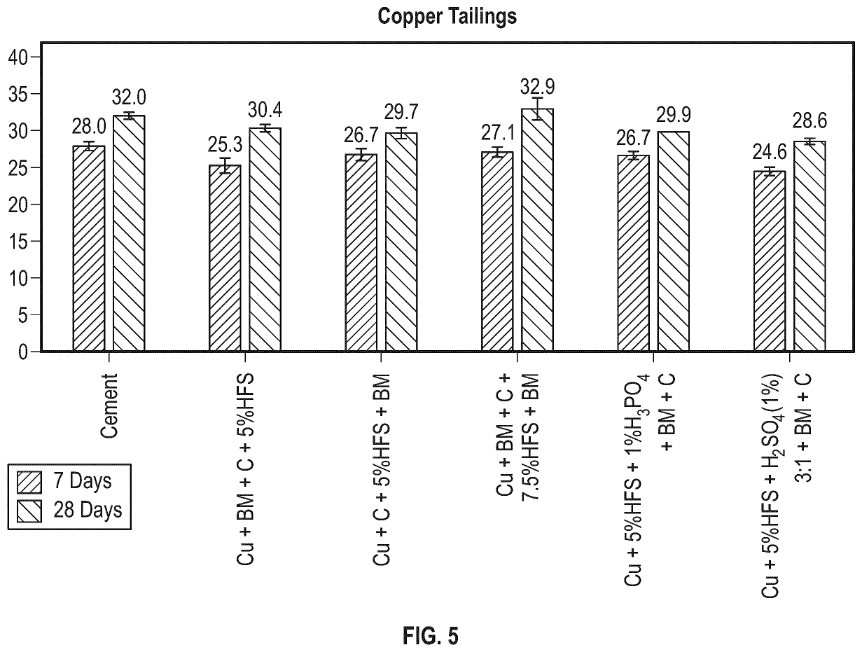

FIG. 5 shows the compressive strength of SCM prepared from copper tailings after 7 and 28 days. The compressive strength of the mortar samples prepared with 20% of SCM from copper tailings is shown. SCMs from copper tailings (“Cu”) with hexafluorosilicic (“HFS”) acid, ball milling (“BM”), calcination (“C”), sulfuric acid (“H₂SO₄”), and/or phosphoric acid (“H₃PO₄”) are compared to cement. The compressive strength of the SCMs from copper tailings was not significantly different than cement.

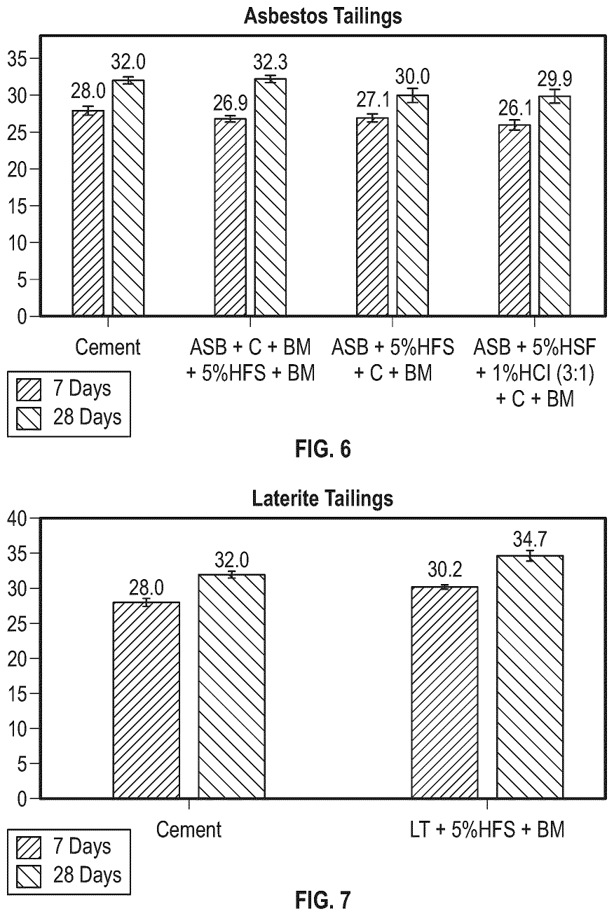

FIG. 6 shows the compressive strength of SCM prepared from asbestos tailings after 7 and 28 days. The compressive strength of the mortar samples prepared with 20% of SCM from asbestos tailings is shown. SCMs from asbestos tailings (“ASB”) with hexafluorosilicic (“HFS”) acid, ball milling (“BM”), calcination (“C”), and/or hydrochloric acid (“HCl”) were compared to cement. The compressive strength of the SCMs from asbestos tailings was not significantly different than cement.

FIG. 7 shows the compressive strength of SCM prepared from laterite tailings after 7 and 28 days. The compressive strength of the mortar samples prepared with 20% of SCM from laterite tailings is shown. SCM from laterite tailings (“LT”) with hexafluorosilicic (“HFS”) acid and ball milling (“BM”) was compared to cement. The compressive strength of the SCM from laterite tailings was not significantly different than cement.

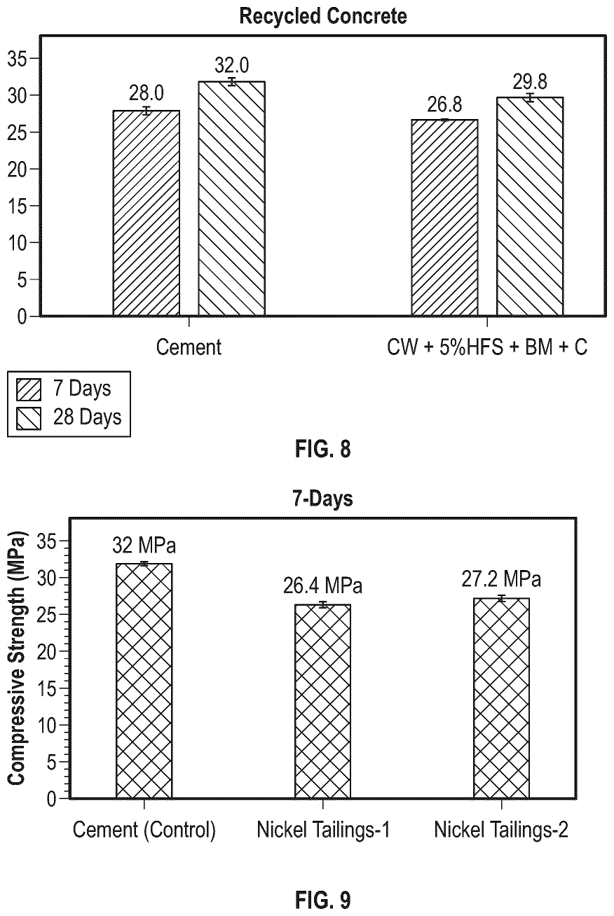

FIG. 8 shows the compressive strength of SCM prepared from recycled concrete after 7 and 28 days. The compressive strength of the mortar samples prepared with 20% of SCM from concrete waste is shown. SCM from concrete waste (“CW”) with hexafluorosilicic acid (“HFS”), ball milling (“BM”) and calcination (“C”) was compared to cement. The compressive strength of the SCM from recycled concrete was not significantly different than cement.

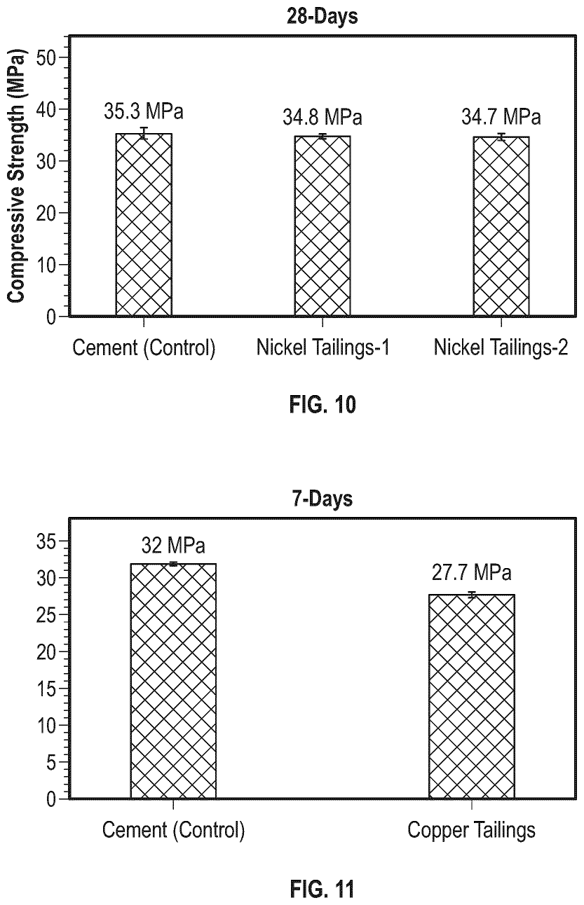

FIGS. 9 and 10 show the compressive strength of SCM prepared from nickel tailings after 7 and 28 days of curing in lime water. The compressive strength of the mortar samples prepared with 20% of SCM from nickel tailings is shown. SCM from nickel tailings with hexafluorosilicic acid (“HFS”) and ball milling (“BM”) are compared to cement. The compressive strength of the SCM from nickel tailings is not significantly different than cement.

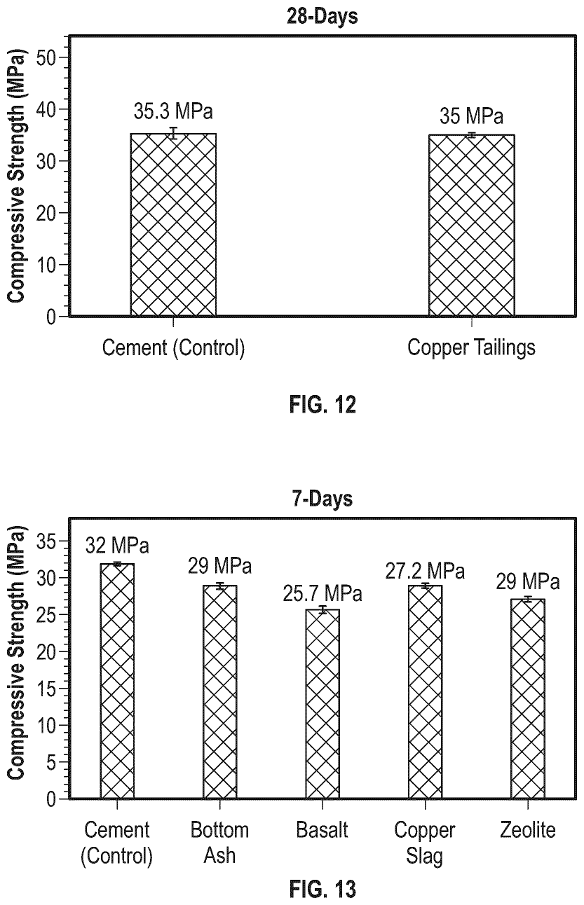

FIGS. 11 and 12 show the compressive strength of SCM prepared from copper tailings after 7 and 28 days of curing in lime water. The compressive strength of the mortar samples prepared with 20% of SCM from copper tailings is shown. SCM from copper tailings with hexafluorosilicic acid (“HFS”) and ball milling (“BM”) is compared to cement. The compressive strength of the SCM from copper tailings is not significantly different than cement.

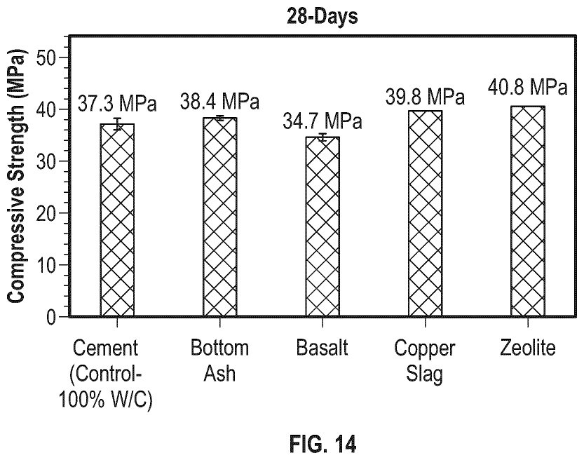

FIGS. 13 and 14 show compressive strength of SCM prepared from bottom ash, basalt, copper slag, and zeolite after 7 and 28 days of curing in lime water. The compressive strength of the mortar samples prepared with 20% of SCM from bottom ash, basalt, copper slag, and zeolite is shown. SCM from bottom ash, basalt, copper slag, and zeolite with hexafluorosilicic acid (“HFS”) and ball milling (“BM”) is compared to cement. The compressive strength of the SCM from bottom ash, basalt, copper slag, and zeolite is not significantly different than cement.

SCM may comprise minerals including, but not limited to, siliceous, siliceous aluminum, aluminous iron, dolomite, calcite, or magnesite minerals, or a combination thereof. SCM may reduce the CO₂ emissions resulting from cement production. The tailings minerals may be activated through either acid activation and milling or combination of low temperature calcination, acid activation, and milling. The tailings feed may be from a variety of feedstock including, but not limited to, oil sands tailings which may be predominantly clay, zinc and lead; copper tailings; base metal tailings; precious metal tailings; nickel laterite tailings; asbestos tailings; coal waste tailings; or a combination thereof. Activation may refer to increased amorphous content of the crystalline tailings feed through structural disordering induced by acid treatment alone or through the combination of acid treatment and calcination. The activated amorphous phase of these tailings minerals may participate in the pozzolanic reaction between portlandite (Ca(OH)₂) from cement to form calcium silicate hydrate (C-S-H). Aluminum in tailings clay may also be present and undergo a similar reaction to form calcium aluminate silicate hydrate (C-A-S-H). The high degree of crystallinity in the tailings minerals may make them unsuitable to participate in the pozzolanic reaction. However, amorphization of the tailings minerals through acid activation or acid activation and calcination, may cause them to be suitable to participate in the pozzolanic reaction and act as a cementitious material.

Acid treatment of tailings minerals comprising clay may result in protons penetrating the mineral layers and attacking the structural OH groups. The resulting dihydroxylation is connected with the successive release of the central atoms from the octahedra as well as with the removal of Al from the tetrahedral sheets. The resulting solid product may comprise unaltered layers and amorphous silica. The acid activation may also increase the specific surface area of tailings mineral and/or clay disposed within the tailings mineral, thereby increasing the reactivity of the tailings. The increase in specific surface area may be further achieved by ball milling of the acid treated tailings and clay disposed within the tailings. This method of pozzolan creation does not overlap with the high temperature calcination of clays (above 700° C.) to form an SCM.

The silicon atoms may be surrounded by oxygen atoms in tetrahedral arrangement (SiO₄⁴⁻) in crystalline silicate structures. Crystalline silicate structures may be associated with one another to allow the structural classification of the silicate minerals, for example neosilicates, sorosilicates, cyclosilicates, phyllosilicates, and tectosilicates. The other constituents of a silicate structure, including but not limited to OH groups and cations, may then be arranged with a silicate group to produce an electrically neutral structure. The strongest association in the tetrahedra are Si and O ions. Metal cation-oxygen bonds may be weaker than silicon-oxygen bonds and may be more susceptible to acid attack. Therefore, mineral dissolution may begin from the release of alkali and alkaline earth cations from the crystal lattice into an acidic solution. The Al—O (predominantly ionic) bonds in the tetrahedra may be less strong that the Si—O bonds. Therefore, upon dissolution in the medium and/or solution in which Al may migrate, the release of Al into the solution predominates over the release of Si. The Si may be accumulated in the solid phase in the form of amorphous compounds.

Dissolution of silicates in hydrofluoric acid may occur at rates orders of magnitude higher than other mineral acids. The addition of hydrofluoric (“HF”) acid may lead to a marked increase in rate of dissolution of silicates. HF acid may be used in a sandstone matrix for example, by acidizing in an oil and gas well, to dissolve siliceous minerals. HFS may be used for silicate dissolution and activation of crystalline silicate minerals present in tailings. HFS is a byproduct of the phosphate fertilizer industry and may be used in some applications such as water fluoridation and cryolite production. However, the large amounts of HFS produced every year are a major environmental pollutant if not disposed of properly. HFS may be used as a source of fluoride for activation of minerals present in tailings which may then be used as an SCM.

The tailings composition as measured using X-ray fluorescence (“XRF”) is given in Table 1 highlighting the major minerals present in the tailings.

TABLE 1
Composition of tailings materials tested

| | Nickel | | | | |
|---|---|---|---|---|---|
| | Laterite | Copper | Asbestos | Zinc & lead | Oil sands |
| Compound | w/w % | w/w % | w/w % | w/w % | w/w % |
| Fe₂O₃ | 60.58 | 15.6 | 8.6 | 2.4 | 4.11 |
| SiO₂ | 7.68 | 37.3 | 37.5 | 42.7 | 39.37 |
| Al₂O₃ | 6.84 | 6.79 | 1.18 | 7.4 | 13.46 |
| CaO | 3.94 | 13.16 | 0.56 | 30 | 0.87 |
| MgO | 0.54 | 15.9 | 37.97 | 8 | 0.6 |

Metal may be extracted from a mineral stream (e.g., mineral tailings and/or waste stream) by contacting the mineral stream with an acid to form an activated mineral stream and a leach liquor. The acid may extract the metal into a leach liquor and the activated mineral stream may be dried and comminuted to form an SCM.

Embodiments of the present invention provide a technology-based solution that overcomes existing problems with the current state of the art in a technical way to satisfy an existing problem for concrete manufactures, contractors, and mining operators. Embodiments of the present invention achieve important benefits over the current state of the art, such as reduced greenhouse gas emissions, improved concrete strength and durability, and economic tailings disposal. Some of the unconventional steps of embodiments of the present invention include acid activation, calcination, and milling of crystalline mineral tailings.

### INDUSTRIAL APPLICABILITY

The invention is further illustrated by the following non-limiting examples.

Examples 1 to 5 describe the compressive strength of the mortar samples prepared with 20% of SCM from oil sand tailings as shown in FIG. 3.

### Example 1

Mature fine tailings (“MFT”) feed was flocculated using polyacrylamide (1100 ppm) and dewatered using a centrifuge. The MFT sludge was then dried to obtain a dry material. The dry material was then mixed with a 5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The SCM produced from oil sands tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 2

MTF feed was flocculated using polyacrylamide (1100 ppm) and dewatered using a centrifuge. The MFT sludge was then dried to obtain a dry material. The dry material was then mixed with a 5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and calcined at 500° C. for 60 minutes. Finally, the acid activated and calcined tailings were ball milled to produce a fine SCM material. The acid-activated clays were further activated using a calciner at a temperature of 500° C., which is lower than commercially available calcined clays that are normally calcined above 700° C. Acid activation of clays prior to calcination reduced the activation temperature for further dehydroxylation. The SCM produced from oil sands tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 3

MFT feed was coagulated using a quaternary ammonium-based coagulant, including benzyl trimethylammonium chloride, (3000 ppm), and dewatered using a centrifuge. The MFT sludge was then dried to obtain a dry material. The dry material was then mixed with a 5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The SCM produced from oil sands tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 4

MFT feed was first treated with sodium silicate to disperse the tailings and remove bitumen using flotation. After flotation, the residual bitumen in the tailings was reduced by 70%. The bitumen was removed to determine its effect on the final SCM performance. The MFT was then flocculated using polyacrylamide (1100 ppm) and dewatered using a centrifuge. The MFT sludge was then dried to obtain a dry material. The dry material was then mixed with a 5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried, and ball milled to produce a fine SCM material. The ball milling was done to ensure that a finer material was produced that fit the fineness criteria listed in ASTM C618 for natural pozzolans. The SCM produced from oil sands tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 5

MFT feed was coagulated using quaternary ammonium-based coagulant, including benzyl trimethylammonium chloride (3000 ppm), and dewatered using a centrifuge. The MFT sludge was then dried to obtain a dry material. The dry material was then mixed with a 7.5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The SCM produced from oil sands tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

Examples 6 to 15 show the compressive strength of the mortar samples prepared with 20% of SCM from zinc tailings as shown in FIG. 4.

### Example 6

Dry zinc tailings were mixed with a 5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The ball milled tailings were then calcined at 500° C. for 60 minutes. The SCM produced from zinc tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 7

Dry zinc tailings were ball milled first to produce a fine material that fits the fineness criteria listed in ASTM C618 for natural pozzolans and to increase the surface area before calcination and subsequent acid activation. The ball mill sample was then calcined at 500° C. for 60 minutes. After calcination the tailings were mixed with a 5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and pulverized to break up any aggregates. The SCM produced from zinc tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 8

Dry zinc tailings were calcined at 500° C. for 60 minutes. After calcination, the tailings were mixed with a 5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The SCM produced from zinc tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 9

Dry zinc tailings were mixed with a 7.5% HFS acid solution to form a slurry. The ratio of dry tailings to acid solution ratio was 3:1. After mixing the tailings and acid, the slurry was left to react for a period of one hour at 80° C. to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The ball milled tailings were then calcined at 500° C. for 60 minutes. The SCM produced from zinc tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 10

Dry zinc tailings were mixed with a 5% HFS acid solution to form a slurry. The ratio of dry tailings to acid solution ratio was 3:1. After mixing the tailings and acid, the slurry was left to react for a period of one hour at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The ball milled tailings were then calcined at 500° C. for 60 minutes. The SCM produced from zinc tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 11

Dry zinc tailings were first ball milled to produce a fine material that fit the fineness criteria listed in ASTM C618 for natural pozzolans and to increase the surface area before calcination and subsequent acid activation. The ball-milled material was then calcined at 500° C. for 60 minutes. After calcination, the tailings were mixed with a 5% HFS acid solution to form a slurry. The ratio of dry tailings to acid solution ratio was 3:1. After mixing the tailings and acid, the slurry was left to react for a period of one hour at room temperature to form a treated tailings sludge. After the reaction period was completed, the treated tailings sludge was dried and ball milled to break up the aggregates instead of pulverization. The SCM produced from zinc tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 12

Dry zinc tailings were mixed with a 5% HFS acid solution. The ratio of dry tailings to acid solution ratio was 3:1 to form a slurry. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The SCM produced from zinc tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 13

Dry zinc tailings were ball milled to produce a fine SCM material. The ball milling was done to ensure a finer material was produced that fit the fineness criteria listed in ASTM C618 for natural pozzolans. The ball milled tailings were then calcined at 500° C. for 60 minutes. The SCM produced from zinc tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 14

Dry zinc tailings were mixed with a 5% solution of aqua regia instead of HFS acid to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The ball milled tailings were then calcined at 500° C. for 60 minutes. The SCM produced from zinc tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 15

Dry zinc tailings were mixed with a mixture of 5% HFS acid solution and 1% H₂SO₄ in a ratio of 3:1 by mass to form a slurry. The ratio of dry tailings to HFS and H₂SO₄ acid solution ratio was 3:1. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The ball milled tailings were then calcined at 500° C. for 60 minutes. The SCM produced from zinc tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

Examples 19 to 23 describe the compressive strength of the mortar samples prepared with 20% of SCM from copper tailings as shown in FIG. 5.

### Example 19

Dry copper tailings were first ball milled to produce a fine material that fit the fineness criteria listed in ASTM C618 for natural pozzolans and to increase the surface area before calcination and subsequent acid activation. The ball-milled material was then calcined at 500° C. for 60 minutes. After calcination the tailings were mixed with a 5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and pulverized to break up any aggregates. The SCM produced from copper tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 20

Dry copper tailings were calcined at 500° C. for 60 minutes. After calcination the tailings were mixed with a 5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The SCM produced from copper tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 21

Dry copper tailings were ball milled first to produce a fine material that fits the fineness criteria listed in ASTM C618 for natural pozzolans and to increase the surface area before calcination and subsequent acid activation. The ball-milled material was then calcined at 500° C. for 60 minutes. After calcination the tailings were mixed with a 7.5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and ball milled to break any up aggregates instead of pulverization. The SCM produced from copper tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 22

Dry copper tailings were mixed with a mixture of 5% HFS acid solution and 1% H₃PO₄ in a ratio of 3:1 by mass to form a slurry. The ratio of dry tailings to HFS and H₃PO₄ acid solution ratio was 3:1. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The ball milled tailings were then calcined at 500° C. for 60 minutes. The SCM produced from copper tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 23

Dry copper tailings were mixed with a mixture of 5% HFS acid solution and 1% H₂SO₄ in a ratio of 3:1 by mass to form a slurry. The ratio of dry tailings to HFS and H₂SO₄ acid solution ratio was 3:1. After mixing the tailings and acid, the slurry was left to react for a period of 12 hours at room temperature to form a treated tailings sludge. After the reaction period was completed, the treated tailings sludge was dried and ball milled to produce a fine SCM material. The ball milling was done to ensure that a finer material was produced that fit the fineness criteria listed in ASTM C618 for natural pozzolans. The ball milled tailings were then calcined at 500° C. for 60 minutes. The SCM produced from copper tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

Examples 24 to 28 describe the compressive strength of the mortar samples prepared with 20% of SCM from asbestos tailings as shown in FIG. 6.

### Example 24

Dry asbestos tailings were calcined at 500° C. for 60 minutes. After calcination the tailings were ball milled to further destruct the asbestos fibers and produce a finer material. After ball milling, the tailings were mixed with a 5% HFS acid solution to form a slurry. The ratio of dry tailings to acid solution ratio was 3:1. After mixing the tailings and acid, the slurry was left to react for a period of 12 hours at room temperature to form a treated tailings sludge. After the reaction period was completed, the treated tailings sludge was dried and ball milled to break up aggregates and produce SCM material. The SCM produced from asbestos tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 25

Dry asbestos tailings were mixed with a mixture of 5% HFS acid solution to form a slurry. The ratio of dry tailings to HFS solution was 3:1. After mixing the tailings and acid, the slurry was left to react for a period of 12 hours at room temperature to form a treated tailings sludge. After the reaction period was completed, the treated tailings sludge was dried, and calcined at 500° C. for 60 minutes. After acid treatment and calcination, the tailings were ball milled to completely destruct the fibers and produce a fine SCM material. The SCM produced from asbestos tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

### Example 26

Dry asbestos tailings were mixed with a mixture of 5% HFS acid solution and 1% hydrochloric (“HCL”) acid in a ratio of 3:1 by mass to form a slurry. The ratio of dry tailings to HFS and HCL acid solution ratio was 3:1. After mixing the tailings and acid, the slurry was left to react for a period of 12 hours at room temperature to form a treated tailings sludge. After the reaction period was completed, the treated tailings sludge was dried and calcined at 500° C. for 60 minutes. After acid treatment and calcination, the tailings were ball milled to completely destruct the fibers and produce a fine SCM material. The SCM produced from asbestos tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

Example 27 describes the compressive strength of the mortar samples prepared with 20% of SCM from laterite tailings as shown in FIG. 7.

### Example 27

Dry laterite tailings were mixed with a mixture of 5% HFS acid solution to form a slurry. The ratio of dry tailings to HFS solution was 3:1. After mixing the tailings and acid, the slurry was left to react for a period of 12 hours at room temperature to form a treated tailings sludge. After acid treatment, the treated tailings sludge was ball milled to produce a fine SCM material that fit the fineness criteria as per ASTM C618. The SCM produced from laterite tailings was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

Example 28 describes the compressive strength of the mortar samples prepared with 20% of SCM from concrete waste as shown in FIG. 8.

### Example 28

Concrete waste was first broken down to remove aggregates and segregate the finer cementitious material. The finer material was then mixed with a mixture of 5% HFS acid solution to form a slurry. The ratio of recycled concrete waste to HFS solution was 3:1. After mixing the concrete waste and acid, the slurry was left to react for a period of 12 hours at room temperature to form concrete waste. After acid treatment, the concrete waste was ball milled to produce a fine SCM material that fit the fineness criteria as per ASTM C618. After ball milling, the concrete waste was calcined at 500° C. for further activation. The SCM produced from concrete waste was then used to replace 20% cement in a mortar mix as outlined in ASTM C311. The mortar mix was allowed to harden to form an SCM-concrete sample. The samples were then tested for compressive strength after 7 and 28 days and compared against a 100% cement control.

Examples 29 to 35 describe the SCM production and metal extraction process from tailings using acid activation process alone.

Examples 29 and 30 describe the treatment of nickel tailings with HFS to extract nickel and other constituents in the leachate. The following activation process does not involve any calcination to further activate the tailings. Addition of higher amounts of HFS alone may activate the mineral streams.

### Example 29

Dry nickel tailings-1 were mixed with a mixture of 1M HFS acid solution in a ratio of 1:1 by mass to form a slurry. The ratio of dry tailings to 1 M HFS solution ratio was 1:1. After mixing the tailings and acid, the slurry was stirred at 60° C. for 1 hour. After the reaction period was completed, the treated tailings slurry was filtered to extract the leached liquor and the sludge was neutralized with lime. The neutralized tailings sludge was dried and ball milled to produce a fine SCM material. The ball milling was done to ensure that a finer material was produced that fit the fineness criteria listed in ASTM C618 for natural pozzolans. The SCM produced from nickel tailings was then used to replace 20% cement in a mortar mix as outlined in ASTM C311. The mortar mix was allowed to harden to form an SCM-concrete sample. The samples were then tested for compressive strength after 7 and 28 days of curing in lime water and compared against a 100% cement control cured in lime water. The amount of nickel extracted in leachate was 1972 ppm as measured through inductively coupled plasma mass spectrometry (“ICP-MS”).

### Example 30

Another set of dry nickel tailings-2 with a slightly different mineralogy were mixed with a mixture of 1M HFS acid solution in a ratio of 1:1 by mass to form a slurry. The ratio of dry tailings to 1 M HFS solution ratio was 1:1. After mixing the tailings and acid, the slurry was stirred at 60° C. for 1 hour. After the reaction period was completed, the treated tailings slurry was filtered to extract the leached liquor and the sludge was neutralized with lime. The neutralized tailings sludge was dried and ball milled to produce a fine SCM material. The ball milling was done to ensure that a finer material was produced that fit the fineness criteria listed in ASTM C618 for natural pozzolans. The SCM produced from nickel tailings was then used to replace 20% cement in a mortar mix as outlined in ASTM C311. The mortar mix was allowed to harden to form an SCM-concrete sample. The samples were then tested for compressive strength after 7 and 28 days of curing in lime water and compared against a 100% cement control cured in lime water. The amount of nickel extracted in leachate was 700 ppm as measured through (“ICP-MS”).

Example 31 describes the treatment of copper tailings with HFS to extract copper and other constituents in the leachate. The following activation process does not involve any calcination to further activate the tailings. Addition of higher amounts of HFS can solely activate the mineral streams.

### Example 31

Dry copper tailings were mixed with a mixture of 1M HFS acid solution in a ratio of 1:1 by mass to form a slurry. The ratio of dry tailings to 1 M HFS solution ratio was 1:1. After mixing the tailings and acid, the slurry was stirred at 60° C. for 1 hour. After the reaction period was completed, the treated tailings slurry was filtered to extract the leached liquor and the sludge was neutralized with lime. The neutralized tailings sludge was dried and ball milled to produce a fine SCM material. The ball milling was done to ensure that a finer material was produced that fit the fineness criteria listed in ASTM C618 for natural pozzolans. The SCM produced from copper tailings was then used to replace 20% cement in a mortar mix as outlined in ASTM C311. The mortar mix was allowed to harden to form an SCM-concrete sample. The samples were then tested for compressive strength after 7 and 28 days of curing in lime water and compared against a 100% cement control cured in lime water. The amount of copper extracted in leachate was 10996 ppm as measured through ICP-MS.

Example 32 describes the mineral streams with lower pozzolanic activity such as bottom ash, basalt, copper slag and zeolite with HFS to improve the reactivity. The following activation process does not involve any calcination.

### Example 32

Dry bottom ash was mixed with a mixture of 0.5 M HFS acid solution in a ratio of 1:1 by mass to form a slurry. The ratio of bottom ash to 0.5 M HFS solution ratio was 1:1. After mixing the bottom ash and acid, the slurry was stirred at 60° C. for 1 hour. After the reaction period was completed, the treated bottom ash slurry was filtered and neutralized with lime. The neutralized bottom ash sludge was dried and ball milled to produce a fine SCM material. The ball milling was done to ensure that a finer material was produced that fit the fineness criteria listed in ASTM C618 for natural pozzolans. The SCM produced from bottom ash was then used to replace 20% cement in a mortar mix as outlined in ASTM C311. The mortar mix was allowed to harden to form an SCM-concrete sample. The samples were then tested for compressive strength after 7 and 28 days of curing in lime water and compared against a 100% cement control cured in lime water.

### Example 33

Dry basalt was mixed with a mixture of 0.5 M HFS acid solution in a ratio of 1:1 by mass to form a slurry. The ratio of basalt to 0.5 M HFS solution ratio was 1:1. After mixing the basalt and acid, the slurry was stirred at 60° C. for 1 hour. After the reaction period was completed, the treated basalt slurry was filtered and neutralized with lime. The neutralized basalt sludge was dried and ball milled to produce a fine SCM material. The ball milling was done to ensure that a finer material was produced that fit the fineness criteria listed in ASTM C618 for natural pozzolans. The SCM produced from basalt was then used to replace 20% cement in a mortar mix as outlined in ASTM C311. The mortar mix was allowed to harden to form an SCM-concrete sample. The samples were then tested for compressive strength after 7 and 28 days of curing in lime water and compared against a 100% cement control cured in lime water.

### Example 34

Dry copper slag was mixed with a mixture of 1 M HFS acid solution in a ratio of 1:1 by mass to form a slurry. The ratio of copper slag to 1 M HFS solution ratio was 1:1. After mixing the copper slag and acid, the slurry was stirred at 60° C. for 1 hour. After the reaction period was completed, the treated copper slag slurry was filtered and neutralized with lime. The neutralized copper slag sludge was dried and ball milled to produce a fine SCM material. The ball milling was done to ensure that a finer material was produced that fit the fineness criteria listed in ASTM C618 for natural pozzolans. The SCM produced from copper slag was then used to replace 20% cement in a mortar mix as outlined in ASTM C311. The mortar mix was allowed to harden to form an SCM-concrete sample. The samples were then tested for compressive strength after 7 and 28 days of curing in lime water and compared against a 100% cement control cured in lime water.

### Example 35

Dry zeolite was mixed with a mixture of 1 M HFS acid solution in a ratio of 1:1 by mass to form a slurry. The ratio of zeolite to 1 M HFS solution ratio was 1:1. After mixing the zeolite and acid, the slurry was stirred at 60° C. for 1 hour. After the reaction period was completed, the treated zeolite slurry was filtered and neutralized with lime. The neutralized zeolite sludge was dried and ball milled to produce a fine SCM material. The ball milling was done to ensure that a finer material was produced that fit the fineness criteria listed in ASTM C618 for natural pozzolans. The SCM produced from zeolite was then used to replace 20% cement in a mortar mix as outlined in ASTM C311. The mortar mix was allowed to harden to form an SCM-concrete sample. The samples were then tested for compressive strength after 7 and 28 days of curing in lime water and compared against a 100% cement control cured in lime water.

The preceding examples can be repeated with similar success by substituting the generically or specifically described reactants and/or operating conditions of this invention for those used in the preceding examples.

Note that in the specification and claims, “about” or “approximately” means within twenty percent (20%) of the numerical amount cited. The terms, “a”, “an”, “the”, and “said” mean “one or more” unless context explicitly dictates otherwise.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A method of producing supplementary cementitious material, the method comprising:
contacting a mineral stream with an acid to form an activated mineral stream;
reducing the moisture content of the mineral stream; and
comminuting the mineral stream to form a supplementary cementitious material.

2. The method of claim 1 wherein the mineral stream comprises tailings.

3. The method of claim 1 wherein the mineral stream is contacted with the acid for about 1 to about 24 hours.

4. The method of claim 1 wherein reducing the moisture content comprises drying.

5. The method of claim 1 wherein comminuting comprises ball milling.

6. The method of claim 1 wherein the acid comprises hexafluorosilicic acid.

7. The method of claim 1 wherein the acid comprises sulfuric acid.

8. The method of claim 1 wherein the acid comprises phosphoric acid.

9. The method of claim 1 further comprising calcining the activated mineral stream.

10. The method of claim 9 wherein the activated mineral stream is calcined at a temperature of about 500° C. to about 700° C.

11. The method of claim 1 wherein the mineral stream comprises asbestos tailings.

12. The method of claim 1 wherein the mineral stream comprises laterite tailings.

13. The method of claim 1 wherein the mineral stream comprises oil sand tailings.

14. A method of extracting a metal from a mineral stream, the method comprising:
contacting a mineral stream with an acid to form an activated mineral stream;
filtering the activated mineral stream to extract leach liquor comprising the metal; and
neutralizing the acid.

15. The method of claim 14 wherein the acid comprises hexafluorosilicic acid.

16. The method of claim 14 wherein the mineral stream comprises tailings.

17. The method of claim 14 wherein the mineral stream comprises sludge.

18. The method of claim 14 wherein the mineral stream comprises slag.

19. The method of claim 14 wherein neutralizing the acid comprises contacting the activated tailings with a caustic.

20. The method of claim 19 wherein the caustic comprises lime.
